(19) United States
(12) Patent Application Publication
(10) Pub. No.: US 2006/0241536 A1
(43) Pub. Date: Oct. 26, 2006

(54) Chair-type massage machine

(76) Inventors: Yuki Yoda, Osaka (JP); Koji Terada, Osaka (JP); Shinji Tsutsui, Osaka (JP)

Correspondence Address: GREENBLUM & BERNSTEIN, P.L.C., 1950 ROLAND CLARKE PLACE, RESTON, VA, 20191, US

(21) Appl. No.: 10/559,412

(22) PCT Filed: May 26, 2004
(86) PCT No.: PCT/JP04/07577

§ 371 Date: Jun. 14, 2006

(30) Foreign Application Priority Data
Jun. 4, 2003 (JP) 2003-160014

(51) Int. Cl. A61H 7/00

(52) U.S. Cl. 601/98; 601/49

(57) ABSTRACT

A leg rest 5 is pivotally secured to a front portion of a seat 2 of a chair 1 for pivotal movement up and down and operable to support calves of a seat occupant sitting on the seat 1, and a footrest 6 is pivotally secured to a front end of the leg rest 5 for supporting feet of the seat occupant sitting on the seat 2 ranging from ankles to toes and soles. The leg rest 5 and the footrest 6 are provided with respective massaging means 7 and 8 incorporated therein. Also, the leg rest 5 is provided with the distance thereof relative to the seat 2 being adjustable, and the footrest 6 is maintained substantially horizontally at all times regardless of the angle and the position of the leg rest 5.

### TECHNICAL FIELD

The present invention relates to a chair type massaging machine and, particularly, to the chair type massaging machine employing a massaging means incorporated in a leg rest that is positioned forwardly of a seat for supporting calves.

### BACKGROUND ART

The massaging machine has hitherto been well known, of a type including a reclining chair made up of a seat, a seat back and a leg rest positioned forwardly of the seat for pivotal movement up and down and having a massaging means incorporated therein.

The massaging machine is also well known, of a type including a reclining chair made up of a seat, a seat back, a leg rest positioned forwardly of the seat and a footrest having a massaging means incorporated therein. In this type of massaging machine, the footrest is held in a generally horizontal position at all times as the leg rest is pivoted up and down (see, for example, Patent Document 1).

Again, the massaging machine equipped with a calf massaging means for applying a massage to the calves and a sole massaging means for applying a massage to the soles is known, in which the sole massaging means can be repositioned to any desired position relative to the calf massaging means (see, for example, Patent Document 2).
Japanese Laid-open Patent Publication No. 2002-238963
Japanese Laid-open Patent Publication No. 2001-95867

In applying a massage to a person, the site at which the massage is applied is generally selected in consideration of the build of the human body and/or the site of fatigue occurring in the person. However, with the massaging machine of the structure disclosed in Patent Document 1, the position of the massaging means cannot be adjusted in consideration of the difference in length of the lower limbs of particular persons desiring to get a massage. Accordingly, if a particular person desiring to get a massage has relatively short lower limbs, the lower limbs do not reach the sole massaging means and, therefore, it is quite often that no sufficient massage is applied to the lower limbs of such person.

On the other hand, with the massaging machine of the structure disclosed in Patent Document 2, if the sole massaging means is repositioned to a position spaced a distance from the calf massaging means, respective sites at which those massages are to be applied with the calf massaging means and the sole massaging means are so separated from each other that no sufficiently smooth blood flow may result in, failing to accomplish a sufficient massaging.

In any event, the massaging machines disclosed in the previously mentioned prior art publications have a common problem in that since the position of the leg rest relative to the seat cannot be adjusted, the user, whose thighs are relatively long relative to the seat of the reclining chair, will suffer from oppression, petrissage and/or strike on his or her knee joint regions and will therefore feel pain or have damaged tendons, when the leg rest is pivoted to a nearly horizontal position.

The present invention has been developed to overcome the above-described disadvantages and has for its objective to provide an improved chair type massaging machine that is effective to apply a satisfactory massage from a lower thigh to toes and to a sole through an ankle regardless of the body build of the user.

### DISCLOSURE OF THE INVENTION

In accomplishing the above objective, the chair type massaging machine according to the present invention includes a leg rest pivotally secured to a front portion of a seat of a chair for pivotal movement up and down and operable to support calves of a seat occupant sitting on the seat, a footrest pivotally secured to a front end of the leg rest for supporting feet of the seat occupant sitting on the seat ranging from ankles to toes and soles, and massaging means incorporated in the leg rest and the footrest, respectively. This chair type massaging machine is characterized in that the leg rest is provided with a distance thereof relative to the seat being adjustable, and the footrest is maintained substantially horizontally at all times regardless of an angle and a position of the leg rest, and in that a distance between the leg rest and the footrest is maintained constant.

Since as hereinabove described the chair type massaging machine includes the leg rest and the footrest each having the massaging means incorporated therein and the footrest is maintained substantially horizontally regardless of the angle and the position of the leg rest, a massage can be applied to the calves and the soles when the leg rest is laid substantially vertically, and since the leg rest and the footrest are held substantially in line with each other when the leg rest is held substantially horizontally, a region ranging from the calves down to the ankles can be massaged. Also, since the distance of the leg rest relative to the seat is adjustable, an optimum massage can be applied to suit to the length of the lower limbs of the user. By way of example, where the user has lower limbs so short that no footrest massaging means reach the soles as discussed previously in connection with the prior art massaging machine, the soles can be brought into contact with the footrest when the leg rest is moved close towards the seat with the distance therebetween reduced, but where the user has long thighs relative to the seat, such user will not suffer from oppression, petrissage and/or strike on his or her knee joint regions, which would otherwise occur when the leg rest is pivoted to the substantially horizontal position, when the leg rest is pivoted to the substantially horizontal position with the distance between the leg rest and the seat increased, and will not therefore feel pain or have damaged tendons, resulting in a high safety.

Also, the distance of the leg rest relative to the seat and the distance of the footrest relative to the seat can be independently and separately adjusted and, in such case, the position of the massaging means can be brought to a position suitable to the user's body build and the site of fatigue so that a high massaging effect can be obtained.

Preferably, pairs of links of an equal length may be secured to a lower portion of the seat and the footrest, respectively, for rotation in a direction conforming to a direction of rotation of the leg rest, in which case a coupling member is arranged between the pairs of the links with the pairs of the links being rotatably connected to the coupling member so as to extend parallel to each other. In such case, since the mechanism for supporting the footrest substantially horizontally regardless of the angle and the position of the leg rest can be constructed in a design of a simplified link mechanism which is inexpensive and can easily be repaired.

Also, the angle of the leg rest or the footrest relative to the seat and the distance between the leg rest or the footrest and the seat may be capable of varying in association with each other. In such case, since the distance between the leg rest or the footrest and the seat increases as the leg rest then pivoting approaches the substantially horizontal position, the position of the rotary axis of the leg rest relative to the seat is positioned downwardly of the rotary axis of the knee joints from the structural standpoint and, therefore, it is possible to avoid an undesirable upward displacement of the position of the leg rest relative to the calves as the leg rest pivots towards the substantially horizontal position and, therefore, the same massaging position can be maintained regardless of the angle of the leg rest.

Moreover, in order for a distance of the leg rest or the footrest relative to the seat to be adjustable, the leg rest or the footrest may be provided for movement in a direction close to and away from the seat and may be capable of being restrained at a desired position. In this case, a biasing means is provided for biasing the leg rest or the footrest towards the seat. By so constructing, the user can easily adjust the position of the massaging means to a position appropriate to the user's body build and the site of fatigue with no need to exert any force and, accordingly, the user can have a sense of being highly relaxed. Also, since the biasing means for biasing so as to achieve a movement necessary to reduce the distance between the leg rest or the footrest and the seat is employed, any load resulting from the weight of the leg rest or the footrest can be reduced when the distance between the leg rest or the footrest and the seat is adjusted. In addition, where the movement of the leg rest or the footrest is carried out by the drive of a drive mechanism, a low output from the drive mechanism is sufficient to achieve an energy saving and, also, even where the movement is effected manually, a small force is sufficient to accomplish the adjustment and, therefore, the user can fee) highly relaxed.

Yet, if the biasing means for biasing the leg rest or the footrest in a direction towards the seat is employed in the form of an elastic element, it is inexpensive.

Where means for controlling a speed of movement is employed for adjusting the distance between the leg rest or the footrest and the seat, it is possible to avoid an abrupt movement of the leg rest or the footrest by the action of the biasing force of the biasing means such as, for example, the elastic element simultaneously with release of the leg rest or the footrest then fixed in position and, accordingly, a high safety can be obtained. In addition, as an added value of the product, the chair type massaging machine of the present invention can have a touch of class.

Furthermore, if the value of the force applied to reduce the distance between the leg rest or the footrest and the seat, from which the weight of the leg rest and the weight of the footrest are subtracted, is set to be not greater than 10 kgf, even the user having no much strength, for example, a child or an aged person, can easily perform an operation to adjust the position of the leg rest or the footrest.

It is preferred that guide mechanisms be provided for varying the distance between the leg rest or the footrest and the seat. Those guide mechanisms are preferably provided in two or more rows in parallel relation to each other within a plane parallel to a body support face of the leg rest or the footrest. Each of those guide mechanisms may include a generally U-sectioned rail having a face parallel to the body support face of the leg rest or the footrest, which is opened towards an outside, two or more disc-shaped rollers each rotatable about an axis perpendicular to the body support face of the leg rest or the footrest and having a diameter substantially equal to an inner width of the generally U-shaped section of the respective rail and arranged in a row longitudinally of the respective rail, and rotary shafts for the rollers.

As hereinabove described, in the event that the moment is brought about to the guide mechanisms by the force necessary to adjust the distance between the leg rest or the footrest and the seat, the rollers are brought into contact with the side faces of the rails, respectively, with the friction minimized and, therefore, the rollers can be smoothly moved without clinging to the rails. Also, since the force necessary to support the user's body acting vertically on the leg rest or the footrest is received by flat faces of the rollers, it can withstand a large load.

### BRIEF DESCRIPTION OF THE DRAWINGS

FIG. 1 is a perspective view showing the entire structure of a chair type massaging machine according to a preferred embodiment of the present invention.

FIG. 2 is a schematic side view showing an operating mechanism for driving a leg rest and a base frame both employed in the chair type massaging machine shown in FIG. 1.

FIG. 3 is a schematic side view showing a modified form of the operating mechanism for driving the leg rest and the base frame both employed in the chair type massaging machine shown in FIG. 1.

FIG. 4 is a view showing the leg rest and the base frame as viewed from a seat.

FIG. 5 is a fragmentary side view showing a portion of the drawing of FIG. 4.

FIG. 6 is a fragmentary perspective view showing a portion of a guide mechanism for the leg rest.

FIG. 7 is a schematic side view showing a further modified operating mechanism for driving the leg rest and the base frame.

### BEST MODE FOR CARRYING OUT THE INVENTION

Hereinafter, a preferred embodiment of the present invention will be described with reference to the accompanying drawings.

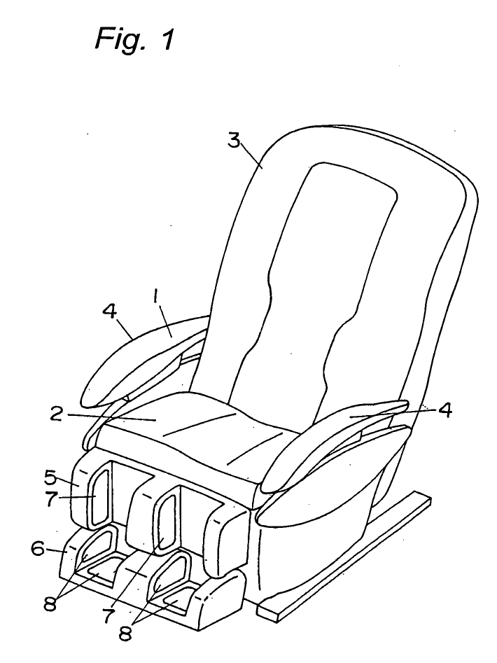

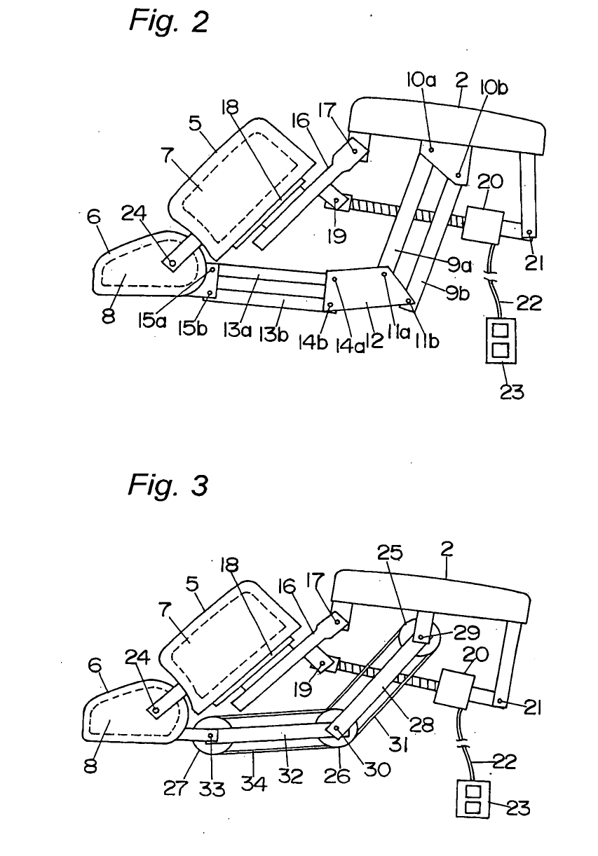

FIGS. 1 and 2 illustrate a chair type massaging machine according to the present invention, which is in the form of a chair 1 made up of a seat 2, a reclining seat back 3, a pair of armrests 4, a leg rest 5 and a footrest 6. The leg rest 5 is for supporting calves of a seat occupant sitting on the seat 2 and the footrest 6 is for supporting feet of the seat occupant sitting on the seat 2, particularly her or his foot regions ranging from ankles to toes and soles. The leg rest 5 and the footrest 6 are equipped with respective massaging means 7 and 8. In the illustrated embodiment, the footrest 6 is drivingly coupled, and operatively associated, with the leg rest 5 by means of one or more pivot pins 24 that are arranged in the leg rest 5 for pivotal movement in a direction forwardly and rearwardly of the massage chair 1, while the leg rest 5 and the footrest 6 are spaced a predetermined distance from each other.

A pair of first parallel links 9a and 9b of an equal length are positioned below the seat 2 and are connected at one end with the seat 2 by means of associated pivot pins 10a and 10b so that the first parallel links 9a and 9b can pivot in a direction forwardly and rearwardly of the massage chair 1. Opposite ends of the first parallel links 9a and 9b are pivotally connected through corresponding pivot pins 11a and 11b with a coupling plate 12 that defines an intermediate joint. Since the distance between the pivot pins 10a and 10b and the distance between the pivot pins 11a and 11b are so chosen as to be equal to each other, the first links 9a and 9b are parallel to each other at all times and the straight line between the pivot pins 10a and 10b and the straight line between the pivot pins 11a and 11b are also parallel to each other at all times.

On one side of the intermediate joint opposite to the pair of the first parallel links 9a and 9b, a pair of second parallel links 13a and 13b of an equal length are connected at one end pivotally with the coupling plate 12 through pivot pins 14a and 14b and at the other end pivotally with the footrest 6 through pivot pins 15a and 15b. As is the case with the pair of the first parallel links 9a and 9b, the distance between the pivot pins 14a and 14b and the distance between the pivot pins 15a and 15b are so chosen as to be equal to each other and, therefore, the second links 13a and 13b are parallel to each other at all times and the respective straight lines between the pivot pins 14a and 14b and between the pivot pins 15a and 15b are also parallel to each other at all times.

Since the pivot pins 11a and 11b and the pivot pins 14a and 14b are secured to the coupling plate 14a and, therefore, the angle between the straight line, drawn to connect between the pivot pins 11a and 11b, and the straight line drawn to connect between the pivot pins 14a and 14b is naturally fixed, the angle between the straight line, drawn to connect between the pivot pins 10a and 10b, and the straight line drawn to connect between the pivot pins 15a and 15b is also fixed. Accordingly, the angle of the footrest 6 relative to the seat 2 is fixed at all times, allowing the footrest 6 to assume a substantially horizontal position at all times.

A base frame 16, which defines a base for the leg rest 5, is drivingly connected with a front region of the seat 2 through a pivot pin 17 for pivotal movement in a direction forwardly and rearwardly of the massage chair 1. The leg rest 6 is mounted on the base frame 16 for movement in a direction lengthwise of guide mechanisms 18. The base frame 16 for the support of the leg rest 5 is operatively connected through a pivot pin 19 with one end of a telescoping mechanism 20, which is in turn connected at the opposite end with a lower region of the seat 2 through a pivot pin 21. The telescoping mechanism 20 may be any known extender of a design, in which one of a nut and a screw shaft, when driven, can move relative to the other and, therefore, the details thereof are not described for the sake of brevity.

This telescoping mechanism 20 has a connecting cable 22 that is electrically connected with a controller 23 and, accordingly, by manipulating this controller 23, the telescoping mechanism 20 can selectively extend or contract. Hence, when the telescoping mechanism 20 extends, the base frame 16 for the support of the leg rest 5 pivots about the pivot pin 17 forwardly of the massage chair 1 in a direction approaching a horizontal position to assume a generally horizontal position, but when the telescoping mechanism 20 contracts, the base frame 16 for the support of the leg rest 5 pivots in a direction approaching a vertical position to assume a generally vertical position.

FIG. 3 illustrates a different example of a mechanism for maintaining at a constant value the angle of the footrest 6 relative to the seat 2. In the following description made with reference to FIG. 3, component parts shown in FIG. 3, but alike those shown and described with reference to FIG. 2 are shown by like reference numerals employed in FIG. 2 and only the difference between the mechanism shown in FIG. 2 and the mechanism shown in FIG. 3 will be described for the sake of brevity.

In the modification shown in FIG. 3, a first pulley 25 is secured to an undersurface of the seat 2 and a link 28 is rotatably coupled at one end with a center of the first pulley 25 through a rotary pin 29. The opposite end of the link 28 is coupled with a center of a second pulley 26 through a rotary pin 30. The second pulley 26 has two circumferentially extending grooves around which respective endless belts 31 and 34 can be trained. Specifically, the endless belt 31 is drivingly trained between the first pulley 25 and the second pulley 26 and the transmission ratio between the first pulley 25 and the second pulley 26 is so chosen as to be 1:1.

A link 32 is pivotally connected at one end with the center of the second pulley 26 through a rotary pin 30, the opposite end of which link 32 is pivotally connected through a rotary pin 33 with a center of the third pulley 27 which is secured to the footrest 6. Since as hereinbefore described the second pulley 26 has the two circumferentially extending grooves with the endless belt 31 occupying one of those grooves, an endless belt 34 is trained between the second pulley 26 and the third pulley 27 and the transmission ration between the second pulley 26 and the third pulley 27 is so chosen as to be 1:1.

Considering that the transmission ratio between the first pulley 25 and the second pulley 26 is 1:1 and the transmission ratio between the second pulley 26 and the third pulley 27 is similarly 1:1, the transmission ratio between the first pulley 25 and the third pulley 27 is accordingly 1:1 and, hence, no relative change in angle occurs. The first pulley 25 is fixed in position, that is, held non-rotatable relative to the seat 2 and, similarly, the third pulley 27 is fixed in position or held non-rotatable relative to the footrest 6. Accordingly, the angle of the footrest 6 relative to the seat 2 is fixed at all times.

It is to be noted that although in the illustrated modification the transmission ratio between the first pulley 25 and the second pulley 26 has been described as chosen to be 1:1 and, similarly, the transmission ration between the second pulley 26 and the third pulley 27 has been described as chosen to be 1:1, similar effects can be obtained even if the transmission ratio between the first pulley 25 and the second pulley 26 is chosen to be 1:x and, similarly, the transmission ration between the second pulley 26 and the third pulley 27 is chosen to be x:1. It is also to be noted that in place of the use of a combination of the pulleys and the belts, a combination of endless chains and sprockets can be equally employed.

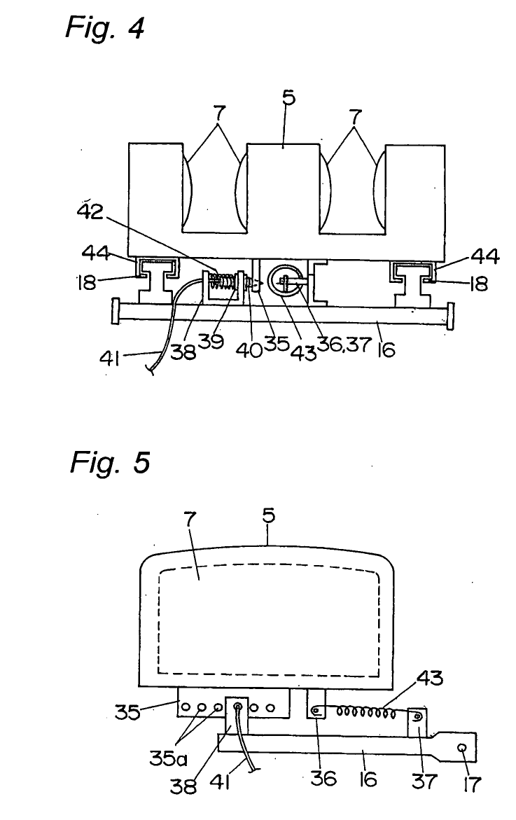

A mechanism for selectively restraining and releasing the leg rest 5 relative to the base frame 16 one at a time will now be described with particular reference to FIGS. 4 and 5. FIG. 4 illustrates a diagram of the leg rest 5 and the base frame 16 as viewed from the seat and FIG. 5 illustrates a diagram of the leg rest 5 and the base frame 16 as viewed from one side. It is, however, to be noted that for facilitating a better understanding of the mechanism, the guide mechanisms 18 are not shown in FIG. 5.

The leg rest 5 is mounted on the base frame 16 through the two guide mechanisms 18, arranged in parallel relation to each other, for movement only in a direction lengthwise of the guide mechanisms 18 between a close position nearing the seat 2 and a remote position remote from the seat 2. A fixed plate 35 having a straight row of perforations 35a, defined therein in a direction conforming to the direction of the leg rest 5 relative to the base frame 16, and a spring anchor 36 are fixed to an undersurface of the leg rest 5.

On the other hand, another spring anchor 37 and a support bracket 38 are fixed to an upper surface of the base frame 16. The support bracket 38 has a bearing 39 fixed thereto and a slide rod 40 is slidable in a direction axially of the bearing 39. This slide rod 40 is selectively engageable and disengageable relative to the fixed plate 35 in a direction perpendicular to the latter and is engaged in one of the perforations 35a in the fixed plate 35 when the slide rod 40 is projected. By the action of a compression spring 42 interposed between the support bracket 38 and the slide rod 40, the slide rod 40 is normally biased so as to project towards the fixed plate 35. One end of the slide rod 40 opposite to the end thereof that is engageable with the fixed plate 35 is connected with a wire 41 and, when this wire 41 is pulled, the slide rod 40 can be disengaged from the fixed plate 35.

A tension spring 43 has its opposite ends engaged to the spring anchors 36 and 37, respectively, and, therefore, the leg rest 5 is normally urged at all times towards the spring anchor 37 and, hence, towards the seat 2 with the distance between the leg rest 5 and the seat 2 tending to be minimized. Although not specifically shown, the opposite end of the wire 41 remote from the support bracket 38 is connected with an operating instrument arranged in the seat 2, one of the arm rests 4 or any other position to which the user can easily make access.

In this arrangement, unless the wire 41 is pulled, the leg rest 5 is held in position fixed to the base frame 16 with no change occurring in the distance between the leg rest 5 and the seat 2. However, when the wire 41 is pulled, fixture of the leg rest 5 to the base frame 16 is released to allow the leg rest 5 to move away from the seat 2 if an external force acting on the leg rest 5 in a reverse direction is higher than the force exerted by the tension spring 43, but to allow the leg rest 5 to move close towards the seat 2 if the external force acting on the leg rest 5 in the reverse direction is lower than the force exerted by the tension spring 43.

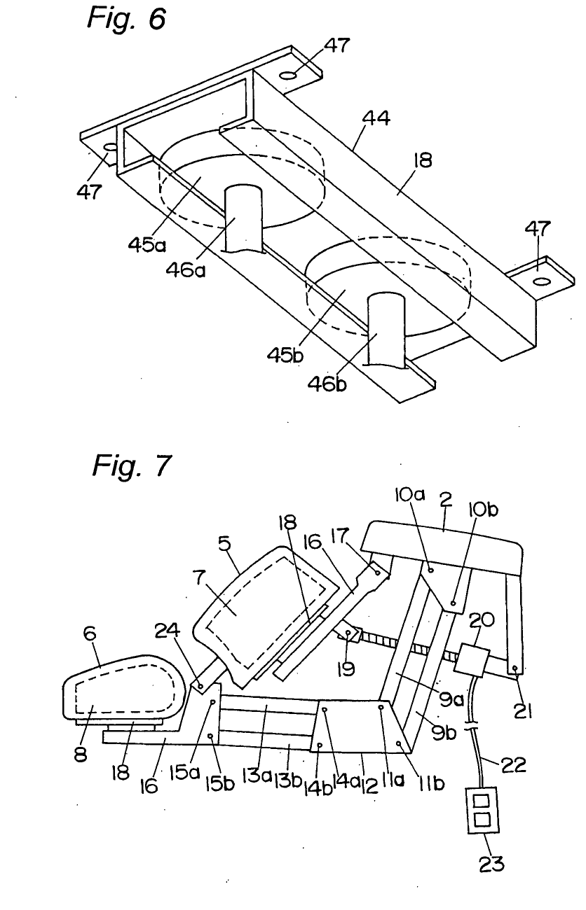

One example of one of the guide mechanisms 18 will now be described with particular reference to FIG. 6. Each guide mechanism 18 includes a rail 44, disc-shaped rollers 45a and 45b and rotary shafts 46a and 46b. The rail 44 is rigidly secured to the undersurface of the leg rest 5 by means of fixtures 47. This rail 44 is of a generally U-sectioned configuration having lips integral therewith and a portion of one of surfaces thereof opposite to the fixtures 47 is opened towards the outside. The rollers 45a and 45b are arranged inside the rail 44 in a row conforming to the lengthwise direction of the rail 44 and, although not specifically shown, those rollers 45a and 45b are rotatably fitted to the base frame 16 through the corresponding rotary shafts 46a and 46b. Each of the rollers 45a and 45b has a diameter substantially equal to the inner width of the rail 44. In this structure, when a moment acting on the guide mechanism 18 is generated by a force used to adjust the distance between the leg rest 5 and the seat 2, the roller 45a contacts one of inner side faces of the rail 44, while the roller 45b contacts the other of the inner side faces of the rail 44, and those rollers 45a and 45b move rollingly within the rail 44.

FIG. 7 illustrates a different chair type massaging machine. Since the example shown in FIG. 7 is basically similar to that shown in and described with reference to FIG. 2, only the difference therebetween will be described for the sake of brevity.

While in the previously described example, the leg rest 5 and the footrest 6 have been shown and described as movable in unison with each other to adjust the position thereof relative to the seat 2, the leg rest 5 and the footrest 6 in the example shown in FIG. 7 move independently from each other to adjust the position relative to the seat 2. In the example shown in FIG. 7, the footrest 6 has a base frame 16 in a manner similar to the leg rest 5. The respective other ends of the second parallel links 13a and 13b are connected through the respective pivot pins 15a and 15b with the base frame 16 for the footrest 6, and the pivot pins 24 provided in the leg rest 5 are connected with the base frame 16 for the footrest 6.

In a manner similar to the leg rest 5, the footrest 6 is movably mounted on the base frame 16 for the footrest 6 through guide mechanisms 18. Not only those guide mechanisms 18, but also a mechanism for selectively restraining and releasing the footrest 6 one at a time and the use of a tension spring 43 for biasing the footrest 6, all employed in association with the footrest 6, are substantially similar to those employed in association with the leg rest 5 and are so constructed as shown in FIGS. 4 to 6. Even in this example, regardless of the angle and the position of the leg rest 5, the footrest 6 can be maintained horizontally at all times and, independent from the leg rest 5, the distance of the footrest 6 relative to the seat 2 can also be adjusted as desired.

The chair type massaging machine of the present invention is so constructed as hereinbefore described. Specifically, any of the chair type massaging machines shown in and described with reference to FIGS. 2, 3 and 7, respectively, is provided with the leg rest 5 and the footrest 6 including the respective massaging means 7 and 8. In any of those chair type massaging machines, since the footrest 6 is designed to be maintained substantially horizontally regardless of the angle and the position of the leg rest 5, a massage can be applied to the calves and soles when the leg rest 5 lies substantially vertically, and since on the other hand the leg rest 5 and the footrest 6 are held substantially in line with each other when the leg rest 5 is held substantially horizontally, a massage can be applied to a wide range from the calves down to the ankles. Also, since the distance of the leg rest 5 relative to the seat 2 can be adjusted when the leg rest 5 is moved along and by the guide mechanisms 18, a massage appropriate to the length of the user's lower limbs can be applied properly.

With the chair type massaging machine of the structure shown in FIG. 7, the distance of the leg rest 5 relative to the seat 2 and the distance of the footrest 6 relative to the seat 2 can be adjusted independently and separately and, therefore, the position of the massaging means can be adjusted to fit to the body build of the user and the site of fatigue to allow the user to enjoy a high massaging effect.

Also, owing to the use of link mechanisms including the first parallel links 9a and 9b, the second parallel links 13a and 13b and the coupling plate 12 as employed in the respective examples of FIGS. 2 and 7, where the footrest 6 is designed to be maintained substantially horizontally regardless of the angle and the position of the leg rest 5, each of those link mechanisms can be of a simplified and inexpensive structure and can also easily be repaired. Where a mechanism for supporting the footrest 6 substantially horizontally regardless of the angle and the position of the leg rest 5 is made up of the first, second and third pulleys 25, 26 and 27, the belts 31 and 34 and the links 28 and 32 as employed in the example of FIG. 3, the distance on a pulling side and a slackening side of each of the belts 31 and 34 remains constant regardless of the angle and the position of the leg rest 5, and there is no possibility of user's fingers being jammed, thereby providing a high safety.

In view of the fact that as hereinbefore described, the leg rest 5 or the leg rest 5 and the footrest 6 move relative to the base frame 16 or the base frames 16, it is possible to drivingly associate the leg rest 5 and the footrest 6 with each other so that the position of the leg rest 5 and the footrest 6 can be changed depending on the angle of the leg rest 5 during the use. Accordingly, since as the leg rest 5 is pivoted to assume a substantially horizontal position, they are drivingly associated with each other so as to considerably vary the distance of the leg rest 5 or the footrest 6 relative to the seat 2 and, also, since in view of the structure of the massage chair 1 the position of the pivot pins of the leg rest 5 relative to the seat 2 lies below the pivot pins of the knee joints, it is possible to prevent the position of the leg rest 5 relative to the calves from being displaced upwardly as the leg rest 5 is pivoted towards the substantially horizontal position and, therefore, regardless of the angle of the leg rest 5, the same site of application of a massage can be maintained.

In addition, the leg rest 5 or the footrest 6 is supported for movement by the guide mechanisms 18 so that they can relatively move close towards each other and away from each other relative to the seat 2 so as to adjust the distance thereof relative to the seat 2 and, by manipulating the wire 41, the slide rod 40 can be engaged in one of the perforations 35a to fix the leg rest 5 or the footrest 6 at a desired position. Accordingly, the massaging means 7 and 8 can be easily set to a position appropriate to the user's body build and the site of fatigue with no need for the user to work himself or herself up, thereby allowing the user to feel relaxed. Also, since the biasing force of the tensile spring 43 is applied to move the leg rest 5 so as to reduce the distance of the leg rest 5 or the footrest 6 relative to the seat 2, the load brought about by the weight of the leg rest 5 or the footrest 6 during the adjustment of the distance of the leg rest 5 or the footrest 6 relative to the seat 2 can advantageously be reduced and, therefore, where the movement of the leg rest 5 or the footrest 6 is carried by the drive of a drive mechanism, a low output from the drive mechanism is sufficient to achieve an energy saving. Also, even where the movement is effected manually, a small force is sufficient to accomplish the adjustment and, therefore, the user can feed highly relaxed.

Yet, when the distance of the leg rest 5 or the footrest 6 relative to the seat 2 is adjusted, the leg rest 5 or the footrest 6 can be smoothly moved due to the biasing force of the tensile spring 43 applied in the manner described hereinbefore. However, where the tensile spring 43 is utilized to pull, there is a possibility that the leg rest 5 or the footrest 6 may be abruptly moved by the effect of a repulsive force of the tensile spring 43 when the leg rest 5 or the footrest 6 is released from the fixed position. In view of this, the use is preferred of a control means such as, for example, a brake device for controlling the abrupt movement of the tensile spring 43. By so doing, it is possible to avoid the abrupt movement of the leg rest 5 or the footrest 6, thereby providing a high safety. Moreover, as an added value of the product, the chair type massaging machine of the present invention can have a touch of class.

Since an operation to selectively restrain and release the leg rest 5 or the footrest 6 can be accomplished through the wire 41 by means of the operating instrument provided in the seat 2 or one of the arm rests 4, the user can, while sitting on the seat 2, adjust the distance between the leg rest 5 or the footrest 6 and the seat 2 by depressing the footrest 6 by the feet to thereby restrain or release the leg rest 5 and can therefore appreciate a relaxed feeling.

Also, the force of the tensile spring 43 is preferably so adjusted that the value of the force applied to reduce the distance between the leg rest 5 or the footrest 6 and the seat 2, from which the weight of the leg rest 5 and the weight of the footrest 6 are subtracted, may not be greater than 10 kgf. By so setting, even the user having no much strength, for example, a child or an aged person, can easily perform an operation to adjust the position of the leg rest 5 or the footrest 6.

Where as shown in FIG. 6 the use is made of the guide mechanisms 18 including the rails 44, the pair of the rollers 45a and 45b and the pair of the rotary shafts 46a and 46b, in the event that the moment is brought about to the guide mechanisms 18 by the force necessary to adjust the distance between the leg rest 5 or the footrest 6 and the seat 2, the rollers 45a and 45b are brought into contact with the side faces of the rails 44, respectively, with the friction minimized and, therefore, the rollers 45a and 45b can be smoothly moved without clinging to the rails 44. Also, since the force necessary to support the user's body acting vertically on the leg rest 5 or the footrest 6 is received by flat faces of the rollers 45a and 45b, it can withstand a large load.

1. A chair type massaging machine comprising:
a leg rest pivotally secured to a front portion of a seat of a chair for pivotal movement up and down and operable to support calves of a seat occupant sitting on the seat;
a footrest pivotally secured to a front end of the leg rest for supporting feet of the seat occupant sitting on the seat ranging from ankles to toes and soles; and
massaging means incorporated in the leg rest and the footrest, respectively;
wherein the leg rest is provided with a distance thereof relative to the seat being adjustable and the footrest is maintained substantially horizontally at all times regardless of an angle and a position of the leg rest; and
wherein a distance between the leg rest and the footrest is maintained constant.

2. A chair type massaging machine comprising:
a leg rest pivotally secured to a front portion of a seat of a chair for pivotal movement up and down and operable to support calves of a seat occupant sitting on the seat;
a footrest pivotally secured to a front end of the leg rest for supporting feet of the seat occupant sitting on the seat ranging from ankles to toes and soles; and
massaging means incorporated in the leg rest and the footrest, respectively;
wherein the footrest is maintained substantially horizontally at all times regardless of an angle and a position of the leg rest; and
wherein a distance of the leg rest relative to the seat and a distance of the footrest relative to the seat are independently and separately adjustable.

3. The chair type massaging machine as claimed in claim 1, further comprising pairs of links of an equal length secured to a lower portion of the seat and the footrest, respectively, for rotation in a direction conforming to a direction of rotation of the leg rest, and a coupling member arranged between the pairs of the links, wherein the pairs of the links are rotatably connected to the coupling member so as to extend parallel to each other.

4. The chair type massaging machine as claimed in claim 1, wherein an angle of the leg rest or the footrest relative to the seat and a distance between the leg rest or the footrest and the seat are capable of varying in association with each other.

5. The chair type massaging machine as claimed in claim 1, further comprising a biasing means for biasing the leg rest or the footrest towards the seat, wherein in order for a distance of the leg rest or the footrest relative to the seat to be adjustable, the leg rest or the footrest is provided for movement in a direction close to and away from the seat and is capable of being restrained at a desired position.

6. The chair type massaging machine as claimed in claim 5, wherein the biasing means for biasing the leg rest or the footrest in a direction towards the seat is an elastic element.

7. The chair type massaging machine as claimed in claim 5, further comprising means for controlling a speed of movement to adjust the distance between the leg rest or the footrest and the seat.

8. The chair type massaging machine as claimed in claim 5, wherein a value of the force applied to reduce the distance between the leg rest or the footrest and the seat, from which the weight of the leg rest and the weight of the footrest are subtracted, is not greater than 10 kgf.

9. The chair type massaging machine as claimed in claim 5, further comprising guide mechanisms provided in a direction in which the distance between the leg rest or the footrest and the seat varies and provided in two or more rows in parallel relation to each other within a plane parallel to a body support face of the leg rest or the footrest, wherein each of the guide mechanisms includes a generally U-sectioned rail having a face parallel to the body support face of the leg rest or the footrest, which is opened towards an outside, two or more disc-shaped rollers each rotatable about an axis perpendicular to the body support face of the leg rest or the footrest and having a diameter substantially equal to an inner width of the generally U-shaped section of the respective rail and arranged in a row longitudinally of the respective rail, and rotary shafts for the rollers.

10. The chair type massaging machine as claimed in claim 2, further comprising pairs of links of an equal length secured to a lower portion of the seat and the footrest, respectively, for rotation in a direction conforming to a direction of rotation of the leg rest, and a coupling member arranged between the pairs of the links, wherein the pairs of the links are rotatably connected to the coupling member so as to extend parallel to each other.

11. The chair type massaging machine as claimed in claim 2, wherein an angle of the leg rest or the footrest relative to the seat and a distance between the leg rest or the footrest and the seat are capable of varying in association with each other.

12. The chair type massaging machine as claimed in claim 2, further comprising a biasing means for biasing the leg rest or the footrest towards the seat, wherein in order for a distance of the leg rest or the footrest relative to the seat to be adjustable, the leg rest or the footrest is provided for movement in a direction close to and away from the seat and is capable of being restrained at a desired position.

13. The chair type massaging machine as claimed in claim 12, wherein the biasing means for biasing the leg rest or the footrest in a direction towards the seat is an elastic element.

14. The chair type massaging machine as claimed in claim 12, further comprising means for controlling a speed of movement to adjust the distance between the leg rest or the footrest and the seat.

15. The chair type massaging machine as claimed in claim 12, wherein a value of the force applied to reduce the distance between the leg rest or the footrest and the seat, from which the weight of the leg rest and the weight of the footrest are subtracted, is not greater than 10 kgf.

16. The chair type massaging machine as claimed in claim 12, further comprising guide mechanisms provided in a direction in which the distance between the leg rest or the footrest and the seat varies and provided in two or more rows in parallel relation to each other within a plane parallel to a body support face of the leg rest or the footrest, wherein each of the guide mechanisms includes a generally U-sectioned rail having a face parallel to the body support face of the leg rest or the footrest, which is opened towards an outside, two or more disc-shaped rollers each rotatable about an axis perpendicular to the body support face of the leg rest or the footrest and having a diameter substantially equal to an inner width of the generally U-shaped section of the respective rail and arranged in a row longitudinally of the respective rail, and rotary shafts for the rollers.
